(19) United States
(12) Patent Application Publication
(10) Pub. No.: US 2010/0243139 A1
(43) Pub. Date: Sep. 30, 2010

(54) Method and Apparatus for Applying Labels to a Rotating Container on a Rotating Turret

(76) Inventors: Thomas Von Hagel, Independence, KY (US); John T. Martin, Cincinnati, OH (US)

Correspondence Address: WOMBLE CARLYLE SANDRIDGE & RICE, PLLC, ATTN: PATENT DOCKETING, P.O. BOX 7037, ATLANTA, GA, 30357-0037, US

(21) Appl. No.: 12/727,588

(22) Filed: Mar. 19, 2010

Related U.S. Application Data
(60) Provisional application No. 61/161,569, filed on Mar. 19, 2009.

(51) Int. Cl. B65C 3/00; B65C 9/04

(52) U.S. Cl. 156/230; 156/538

(57) ABSTRACT

A method and apparatus are disclosed for applying labels to a rotating container on a rotating turret. The apparatus comprises a rotating turret with an array of rotating container bays that can hold containers arrayed about the periphery of the turret. The container bays are configured to rotate containers therein about their axes as the entire turret is rotated about its axis. A label application assembly is disposed adjacent the turret and includes an application roller that is movable by a servo drive radially toward and away from the turret. A label web passes over the application roller. In operation, the turret rotates to bring rotating containers toward the application roller. Before each container aligns with the application roller, the roller moves toward the turret to contact the container surface and begin application of a label. As the container moves into alignment with and past the roller, the roller is retracted and extended in such a way that it maintains contact with or profiles the surface of the container until the label is transferred completely to the container. The turret then speeds up to bring the next container into position for label application, thereby increasing throughput.

### REFERENCE TO RELATED APPLICATION

Priority is hereby claimed to the filing date of U.S. provisional patent application No. 61/161,569 filed on Mar. 19, 2009.

### TECHNICAL FIELD

This disclosure relates generally to the application of labels to containers and more specifically to the application of a heat transfer label to a container rotating about its vertical axis while the container also is rotated about the vertical axis of a handling turret.

### BACKGROUND

Many techniques and devices have been developed for applying decorative heat transfer labels to containers such as, for example, cylindrical plastic containers and beverage bottles. In most, the heat transfer labels are carried by a web and the web is applied to a container as the container is rotated. The rotating container then picks up the label and the rotation of the container causes the label to wrap around and adhere to the surface of the container. It is a primary goal of most heat transfer label applicators to maximize the throughput of the containers being decorated with labels. In many prior art techniques and devices, reaching this goal is hindered by mechanisms that are not continuous but instead inherently start and stop during the label application process. Other processes have label applicator rollers that are part of and move with the turret carrying containers to be decorated. Labels are applied as containers and label rollers move together around the turret. Such mechanisms are complex and can be prone to malfunction. A need exists for a continuous motion label application method and apparatus that maximizes throughput when applying labels, that is less complex in construction and operation, that is more adaptable to different container configurations, and that is more reliable. It is to the provision of such a label application method and apparatus that the present disclosure is primarily directed.

### SUMMARY

The entire content of U.S. provisional patent application No. 61/161,569 is hereby incorporated by reference as if set forth fully herein.

Briefly described, an apparatus for applying heat transfer labels to containers such as cylindrical plastic containers and beverage bottles comprises a handling turret having a plurality of container bays arrayed about its periphery. A loading assembly including a system of conveyors, screws, and star wheels delivers containers to the container bays of the turret in a continuous manner. The loading assembly also may move the containers through a pre-treatment station prior to delivering them to the turret, where the containers may be exposed to heat to prepare their surfaces for receiving labels. The handling turret rotates about its vertical axis, which carries the containers in orbits around the peripheral portion of the turret, and planetary gears associated with the container bays rotate each of the containers about its own vertical axis in the same rotational direction as the turret.

A web transport system includes a web supply roll from which a web bearing heat transfer labels is drawn and a web take-up reel for receiving and winding the spent web after its labels have been applied. The web transport system further includes a label applicator assembly mounted adjacent the turret and having an application head and application roller around which the label web moves. The web transport system is configured to position the label application head and roller parallel to the surface of containers to receive labels. The transport system includes a servo controlled drive mechanism configured to move the application head and roller selectively and in a controlled fashion toward and away from containers orbiting and rotating in the container bays of the turret. In a preferred embodiment, the application head moves in a radial direction with respect to the turret, i.e. toward and away from the center axis of the turret.

In operation, containers are continuously loaded into the container bays of the turret by the loading assembly and carried around the rotating turret in an orbit while simultaneously being rotated about their own vertical axes. As each container approaches the application head, the servo controlled drive mechanism of the applicator assembly positions the applicator head and roller radially in toward the container until the roller and label web extending around the roller contact the surface of the rotating container tangentially. Preferably, this contact occurs at a predetermined angle, which may be about ten (10) degrees, before the container centerline aligns with the application roller, whereupon label application begins as a label is peeled off of the web and is transferred onto the surface of the container.

As the rotating container is carried progressively past the application roller, the servo controlled drive mechanism of the applicator assembly moves the applicator head and roller with a predetermined motion such that the application roller and web contact and track the curvature of the container surface to maintain engagement between the label web and the surface of the container as the container passes the applicator roller. More specifically, the applicator head begins to move outwardly just before contacting the container so that the roller matches the motion of the container surface upon contact. It is thus said that the contact occurs tangentially. The applicator head then moves outwardly and back inwardly as the container passes such that the roller and label web maintain constant contact and pressure with the container to apply a label. At another predetermined angle, which also may be about ten (10) degrees, after the centerline of the container moves beyond the application roller, label application is complete and the servo controlled drive mechanism maintains the applicator head and roller in a ready position until the next successive container approaches, whereupon the cycle repeats.

After application of a label to a container, the container continues to be carried around the turret until it encounters one or more star wheels of an offloading assembly, which removes the containers from the turret and moves them to an out-feed conveyor system that carries the containers away. The offloading assembly may move the containers through a post-treatment station before they are delivered to the out feed conveyor where they may be exposed to heat to gloss out or otherwise treat the newly applied label.

During the label application process, the turret rotational rate is modulated so that it rotates at a higher rate between containers when no label application is occurring than it does during application of a label to a container. This turret modulation increases the time available for label application while lowering surface speed at the point of label application, which is advantageous for the application process. Turret modulation also increases overall throughput.

Thus, an improved method and apparatus is provided for decorating containers with heat transfer labels as the containers orbit continuously around the axis of a turret and simultaneously rotate about their own axes. These and other features, aspects, and advantages of the invention will become clearer upon review of the detailed description set forth below when taken in conjunction with the accompanying drawing figures, which are briefly described as follows.

### BRIEF DESCRIPTION OF THE DRAWINGS

FIG. 1 is a top plan view of an apparatus for applying labels to containers that embodies principles of the disclosure in a preferred form.

FIG. 2 is a perspective view of an apparatus for applying labels to containers showing the turret, the applicator assembly, and portions of the infeed conveyor system.

FIG. 3 is a perspective view of an apparatus for applying labels to containers that illustrates the other side of the applicator assembly, the turret, and portions of the out-feed conveyor system.

FIG. 4 is an enlarged perspective view illustrating a portion of the turret and showing the sun and planetary gears for rotating containers in the container bays.

FIG. 5 is a functional schematic illustration showing in sequential steps A through E the application of a label to a container according to the present disclosure.

FIG. 6 is a schematic illustration showing a simplified drive train for the turret and container bay supports according to the disclosure.

FIG. 7 is a side elevational view of the label application assembly and its controllable servo drive mechanism for controlling movement of the applicator roller toward and away from the turret.

### DETAILED DESCRIPTION

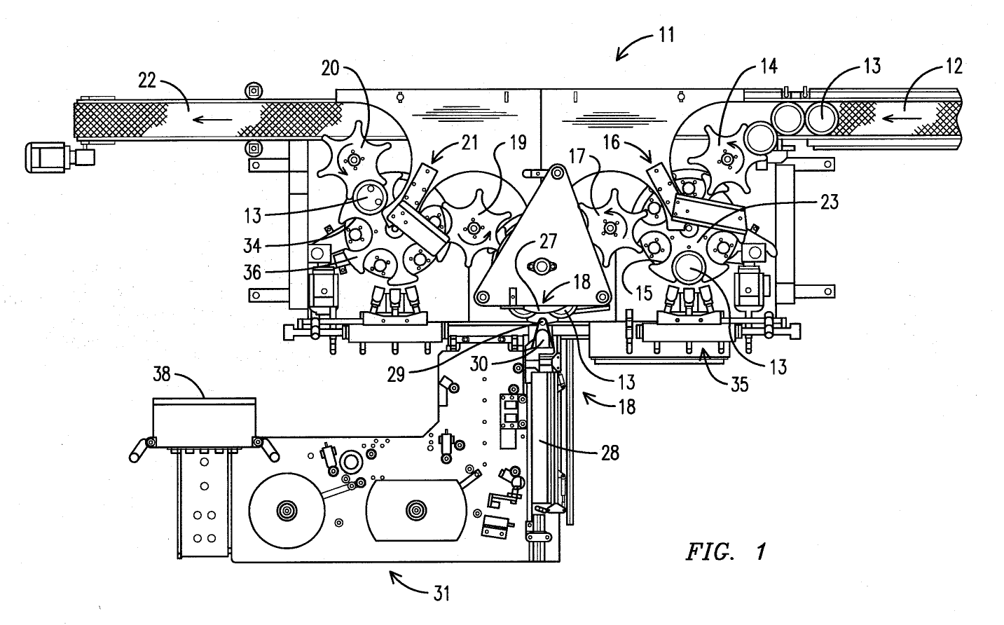

Referring now in more detail to the drawing figures, wherein like reference numerals refer to like parts throughout the several views, FIG. 1 is a top plan view of a label application apparatus according to an embodiment the disclosure. It will be understood that the apparatus shown in FIG. 1 is exemplary only and that the particular configuration of the apparatus may well be different from that shown in FIG. 1. The apparatus 11 comprises an infeed conveyor 12 for conveying containers 13 to functional stations of the apparatus. A rotating star wheel 14 at the downstream end of the infeed conveyor sequentially selects containers 13 and delivers them to a pretreatment station 16, where they are positioned in container bays 15 of a rotating platter 23. As the containers rotate around the rotating platter 23, they may be pre-treated by, for example, being exposed to the heat of a burner or to a hot air stream, which may oxidize or otherwise treat the surfaces of the containers to prepare them for the application of heat transfer labels. In the illustrated embodiment, a pretreatment burner 35 is positioned to direct a gas flame toward containers rotating around the rotating platter 23. Other methods of oxidizing or otherwise treating the surfaces of the containers also may be used such as, for example, applying an oxidizing agent to the surfaces. Further, in some cases, pre-treatment may not be required, in which case the containers may not be treated at all at the pre-treatment station 16.

After traversing station 16, a star wheel 17 removes containers sequentially from the rotating platter 23 and delivers them to a labeling station, generally indicated at 18. The labeling station includes a rotating turret 27 having a plurality of container holding fixtures or bays arrayed around its periphery. As detailed below, a container to be labeled is positioned in each bay of the turret by star wheel 17 and the bays have bases and cap assemblies that are configured to capture and hold the containers firmly for application of labels. Further, the base of each container bay is configured to rotate and thereby to rotate its container about the vertical axis of the container as the container is carried or orbited around the periphery of the turret, which rotates about its own vertical axis. In the preferred embodiment, the containers rotate in the same direction as the turret, although this is not necessarily a requirement. The cap assembly of each bay may include a nozzle for pressurizing each container so that the surfaces of the containers remain resilient as labels are applied.

A label application head assembly 28 is located adjacent to the turret 27 and includes an application roller 29 that is positioned immediately adjacent the turret and containers moving therein. A label web transport system 31 includes supply and take-up reels and a series of rollers, idlers, tensioners, and the like that cooperate to move a web that contains heat transfer labels across the exposed surface of application roller 29. The application head assembly 28 includes a servo drive mechanism (not visible in FIG. 1 but described in detail below) that is controlled by a programmed controller 38 to move the application head assembly 28 and thus the application roller 29 toward and away from containers 13 within the turret 27. More specifically, the application roller 29 is located polar to the turret's rotational axis or centerline and moves in a linear fashion and in a radial direction toward and away from the turret. The surface of the roller 29 is oriented parallel to the surfaces of the containers so that the roller and labels engage the containers with a continuous pressure across the width of the labels.

The application roller 29 has a ready position in which it is positioned as a container to be labeled approaches the roller. The ready position may be just inside the outermost circle swept out by the containers as they move around the turret. As a rotating container in a container bay of the rotating turret approaches the location of the application roller 29, the servo drive begins to move the application head outwardly to match the motion of the surface of the approaching container until the label web thereon comes into tangential contact with the surface of the container. Preferably, this occurs at a predetermined angle, which may be about ten (10) degrees, of turret rotation before the container's vertical axis or centerline aligns with the application roller's centerline. Transfer of a label from the web moving across the roller to the surface of the rotating container begins at this point of contact. More specifically, the leading edge of the label contacts and sticks to the container at this point and the label begins to peel away from the web and is progressively applied to the surface of the container. The controller 38 then controls the servo drive to move the application head and application roller out and back in slightly in such a way that the application roller and the label follows precisely or profiles the curvature of the container's surface as the container moves and rotates past the application roller. In this way, the label web and label thereon is kept in constant contact with the surface of the container for a time sufficient to allow the entire label to roll onto and be applied to the container surface. The rotation rate of the container and the rate of movement of the web across the application roller are synchronized such that the label is transferred smoothly and predictably to the container.

At another predetermined angle, which may also be about ten (10) degrees, of turret rotation after the container centerline moves beyond the centerline of the application roller, the label is fully applied to the container. The servo drive then stops the radial movement of the application head and roller and positions the roller in its ready position for applying a label in the same manner to the next successive container in the turret, and this cycle repeats for each container. Movement of the label web may or may not be stopped between containers, although stopping it may be more efficient since this allows labels to be spaced more closely on the web. In a preferred embodiment, the label web is indexed and positioned such that the next label to be applied is properly located with respect to the application roller. Both roller and web are thus readied for applying a label to the next approaching container in the turret.

The turret rotation, container rotation, and application head movement preferably are independently controlled by respective servo drive mechanisms and each function can be varied and changed as needed to meet the needs of a particular labeling operation, container size or configuration, or other parameters. In the case of the application head and roller movement, an electronic cam profile is programmed into the controller to cause the application roller to follow or profile the container surface as if the application roller were being moved by a physical cam surface and cam follower. However, with the “virtual cam” of this system, this profile can be changed at will to conform to different container sizes and shapes, different application rates, and to meet other requirements that may arise.

The example above describes label application beginning at ten degrees before container and roller centerline alignment and continuing until ten degrees after container centerline alignment for a total of twenty degrees of turret rotation for application of a single label. The invention is not limited to these values, however, and the application roller may engage and disengage from the container surface at different angles such as, for example, fifteen degrees before and after alignment, or five degrees before and after alignment, or combinations therebetween. The size of the container, the size of the label, the rotation rates of the containers, the speed of the web, and the rotation rate of the turret during application all determine the total turret angle during which the application roller and label web stay in contact with the surfaces of the containers. In any event, between label applications, the rotational rate of the turret preferably is increased until a label is to be applied to the next successive container in order to enhance total throughput of the labeling apparatus. In this regard, it has been found advantageous to increase the rate of turret rotation between applications until approximately fifty percent (50%) of the time during a labeling operation is spent applying labels and fifty percent (50%) of the time is spent repositioning the turret between label applications. Other ratios might be selected as well such as, for example, 70-30, 60-40, 40-60 30-70 or the like. Further, the rate of turret rotation need not be varied at all and may simply remain constant, although this is not considered most advantageous for maximizing throughput.

As an example of turret rotation variation, assume, for simplicity, a six bay turret so that there is a total of sixty degrees of turret rotation between the centers of each of the bays. Further assume that twenty degrees of rotation is required to apply a label to a container in each bay, i.e. ten degrees before center and ten degrees after center. Then, for each label application, twenty degrees of turret rotation is spent applying the label and forty degrees of turret rotation is spent repositioning for the next label application. In such a scenario, the rotation rate of the turret during repositioning might be programmed to be twice its rate during label application. In that way, approximately 50% of operational time is spent applying labels and 50% is spent repositioning between label applications. This is advantageous for a number of reasons including that sufficient time for reliable label application is ensured, total machine throughput is maximized, and smooth overall operation of the apparatus is maintained.

Since the container bays and containers therein are rotated by an independent servo drive mechanism, the drive mechanism can be programmed to rotate the next successive container to the proper position to begin to receive a label as the turret is repositioning between applications. For example, the containers to be labeled may have a handle molded into one side such that labels must be applied to the surface of the containers at locations other than where the handle is located. In such an instance, the containers can be indexed to ensure proper label positioning during repositioning of the turret.

Referring again to FIG. 1, after a label has been applied to a container 13 at the label application station 18, the container rotates around the turret until it is removed from its bay by rotating star wheel 19. The star wheel 19 directs the container to a bay 34 of a post treatment platter, where the labeled container may be treated by, for example, being exposed to another flame or to a hot air stream, to gloss out and otherwise set and cure the newly applied label. From post treatment station 21, containers 13 may be removed from their bays by star wheel 20 and moved to out-feed conveyor 22 for delivery to downstream locations.

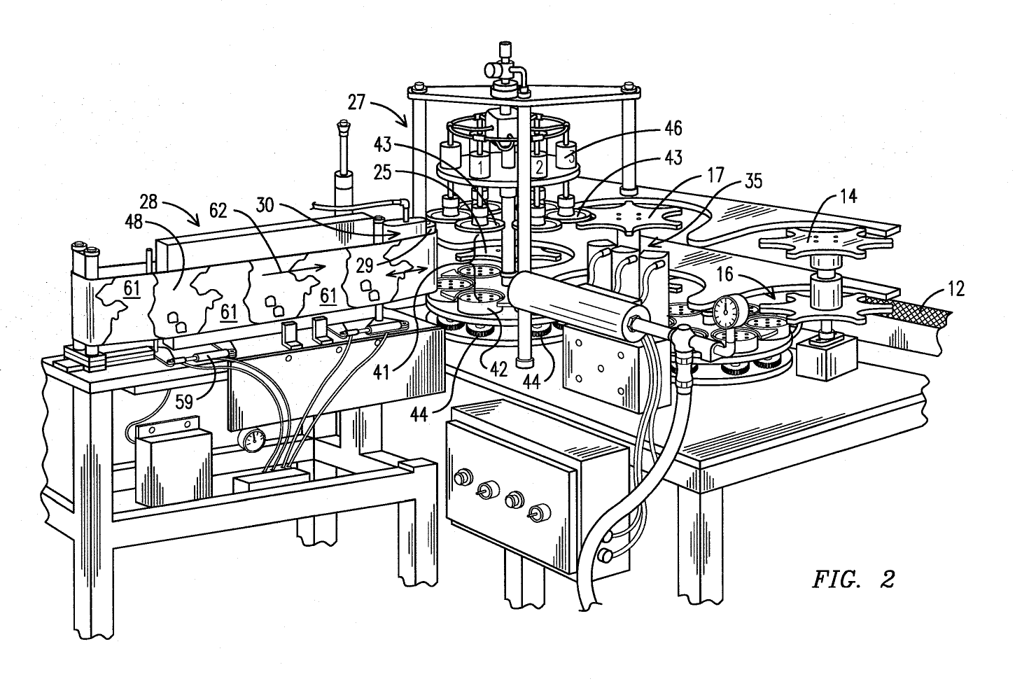

FIG. 2 is a somewhat simplified perspective view of a container labeling apparatus according to one embodiment of the disclosure. Comparing to FIG. 1, the infeed conveyor 12 and the star wheel 14 at the downstream of the infeed conveyor 12 can be seen. The star wheel 14 selects containers from the infeed conveyor as described and delivers them to the pre-treatment station 16 for pre-treating, where required, prior to label application. For example, the containers may be exposed to flames from a gas burner assembly 35 to oxidize the surfaces of containers in preparation for label application. As mentioned, pretreatment also may not be required at all in some cases.

From the pre-treatment station, the containers are delivered by star wheel 17 to the turret 27 and specifically into respective container bays 41 of the turret. The container bays 41 are more clearly visible in FIG. 2 and each bay is seen to comprise a base 42 on which containers 13 rest and a cap assembly 43 driven by a respective actuator 46 to move downwardly onto a container in the bay to capture the container and secure it in the bay. The cap assembly may incorporate a nozzle for injecting a pressurized gas into a container to maintain a level of rigidity or resilience of the container's surface during the label application process. The base 42 is coupled to a planetary gear 44 for rotating a container within the bay as described above. The turret 27 includes a central shaft extending along the rotational axis of the turret and the shaft and turret rotate in a clockwise direction as seen from above in FIG. 1.

The application head assembly 28 is seen located adjacent the turret 27 and includes an application head 30 that has an application roller 29 at its end directly adjacent the turret 27. The application head and roller are movable as indicated by the double headed arrow toward and away from containers within the turret by a servo controlled actuator 59, described in more detail below. In FIG. 2, a web 48 bearing heat transfer labels 61 to be applied to containers is threaded through the web transport system 31 (FIG. 1) and around the application roller 29 for application of labels to containers. The web 48 is moved in a controlled manner by the web transport system generally in the direction of arrow 62 in this embodiment. The servo drive motor 59 is coupled to a programmable controller and the motor responds to commands from the controller, generated by a program, to move the application head assembly toward and away from the turret in a precisely controlled manner, described in more detail below, to apply labels to surfaces of containers in the turret.

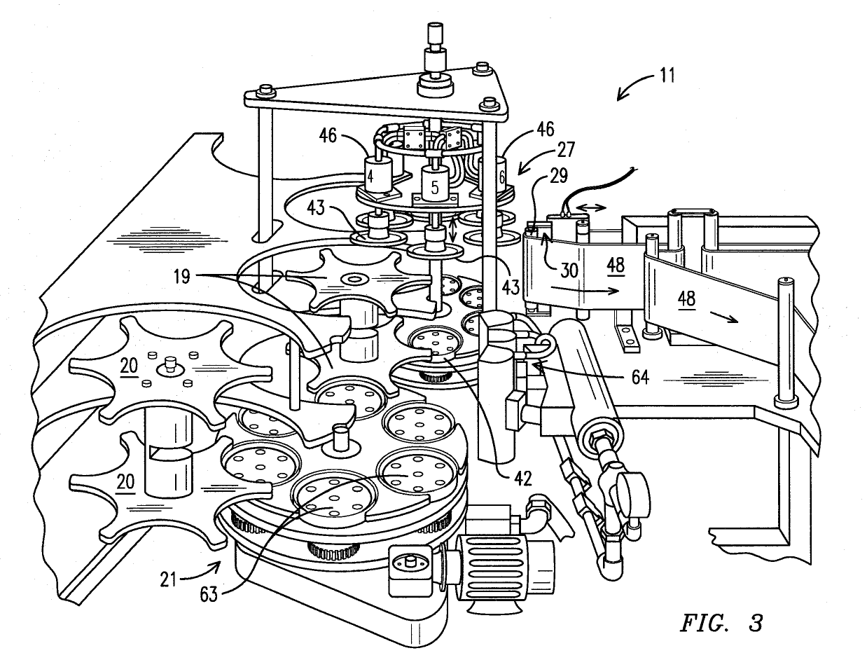

FIG. 3 shows the label application apparatus 11 of this disclosure from another perspective, specifically from the post treatment side of the apparatus. In this figure, the turret 27 is visible as are its container bays, each of which includes a rotatable base 42 and cap assembly 43. It is clearer in this figure that the cap assemblies 43 are selectively movable up and down, as indicated by the double headed arrow, by actuators 46. The cap assemblies 43 thus move down to engage the tops of containers in the bays to secure containers firmly within their bays and, if necessary, to inject pressurized gas into the containers for surface resilience. The application head 28 and its application roller 29 are seen with a label bearing web 48 threaded on the web transport system and extending around the application roller 29. In FIG. 3, the post-treatment station 21 is clearly visible as is the star wheel 19 that removes containers from the turret 27 and transfers them to bays 63 of the post-treatment station for glossing out or other treatment following label application. In the illustrated embodiment, the newly labeled containers may be exposed to a flame issuing from a post treatment gas burner assembly 64. From the post-treatment station, containers are transferred by star wheel 20 to out-feed conveyor 22, which carries the now labeled and glossed out containers downstream to subsequent handling stations.

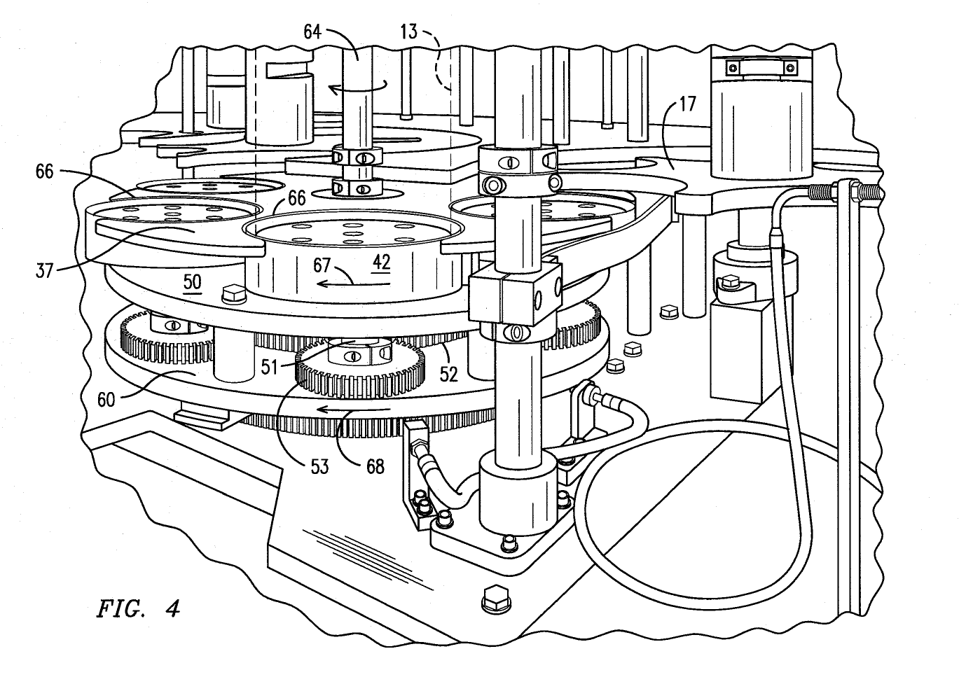

FIG. 4 is an enlarged perspective view of the bottom portion of the turret 27 showing portions of the drive mechanisms of the turret and its container bays. A turret plate 37 is formed with an array of circular cut-outs 66 within each of which a base 42 of a corresponding container bay is rotatably disposed. Each base 42 is mounted on a shaft 51 that is rotatably journaled within bearings (not visible) in support plates 50 and 60. A planetary gear 53 is secured to the shaft 51 between the support plates 50 and 60 and meshes with a sun gear 52 rotatable about the axis of the turret. With this configuration, it will be seen that rotation of the sun gear 52 by its controllable servo drive causes each of the planetary gears and thereby each of the bases, and thus containers 13 disposed thereon, to rotate, as indicated by the arrow 67 in FIG. 4.

The entire turret is rotated about its shaft 64 in the direction of arrow 68 by an independently controllable servo drive. Thus, the turret rotates about its axis and each of the bases, and containers 13 disposed thereon, rotate about their axes simultaneously. As mentioned, the sun gear 52 and the turret shaft 64 are rotatably driven by independently controllable servo drives and drive trains. Thus, the bases 42 and containers thereon can be rotated at a desired rate and in a desired direction independently of the rotational speed and direction of the turret. The servo drives may be controlled by the programmable controller to rotate the bases 42 and the turret in any desired synchronized or unsynchronized relationship. In this way, containers of varying sizes and configurations and labels of varying sizes and configurations can be accommodated easily through appropriate programming of the controller. In the preferred embodiment, the bases rotate in the same direction as the turret, as indicated by the arrows; however, this is not necessarily a requirement of the invention.

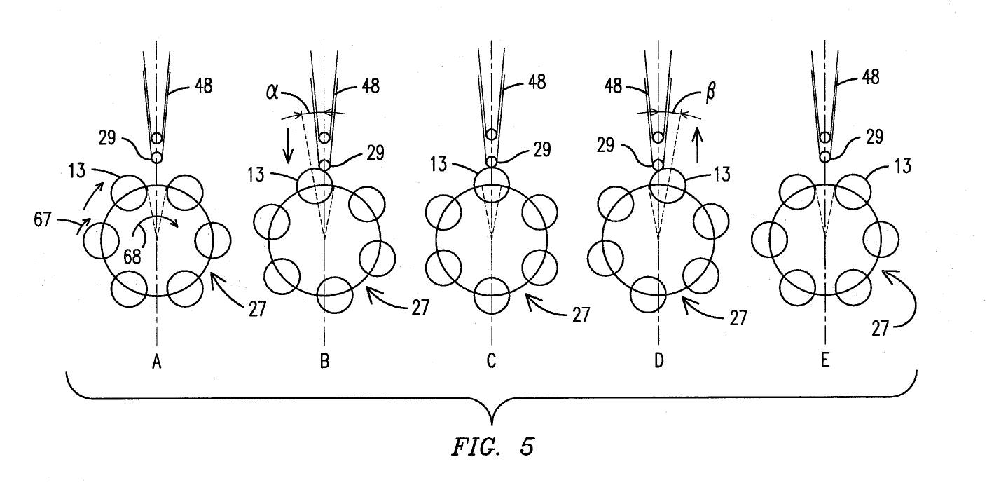

Having described the mechanism, FIG. 5 illustrates, in schematic form and sequentially from A through E, the process by which labels are applied to containers according to the method and apparatus of this disclosure. In sequence A, the turret 27 is shown schematically from the top rotating about its axis in a clockwise direction indicated by arrow 68. Containers 13 disposed in the container bays of the turret also are being rotated by the bases of the container bays in a clockwise direction about the respective axes of the containers as indicated by arrow 67. The application roller 29 is seen disposed adjacent to the turret and aligned parallel to the surfaces of the containers. The application roller is selectively movable by its servo actuator toward and away from the assembly along a path that is radial or polar relative to the turret. In sequence A, the turret is repositioning for application of a label to the approaching container 13. The application roller 29 has been moved by its servo actuator to its ready position located between two containers 13 and just inside the outermost circumference swept out by the containers 13. The container 13 thus approaches contact with the roller as the turret rotates.

In sequence B, the center or axis of the container 13 has reached a position forming a predetermined angle α with respect to the center of the application roller. The angle α may be any appropriate angle depending upon the size of the container, the size of the labels to be applied, or other factors, but generally has been found to be from about 5 degrees to about 15 degrees for most containers. In the illustrated embodiment, angle α is about 10 degrees. When the container surface reaches the position shown in sequence B, the application head, application roller, and the label web 48 extending around the roller make tangential contact with the surface of the container. More specifically, the servo drive of the application head begins moving the application roller outwardly just before the container arrives and makes contact so that the roller matches the motion of the container surface at the instant of contact to insure a smooth engagement between the roller and the container. At this point, a label of the label web contacts and sticks to the container and begins to be progressively peeled off of the label web 48 and transferred to the surface of the container 13 as the container and the turret rotate past the application roller. The label web also is moved around the roller at a rate substantially matching the surface speed of the container, which is a composite of the rotational speeds of the turret and the container bases, so that the label is progressively released from the web and progressively rolled onto the surface of the container in a smooth controlled manner.

In sequence C, the container 13 has rotated to a position wherein its center or axis is aligned with the axis of the application roller 29 and the first section of the label has been applied to the container 13. As the container moves through angle α to this position, the servo drive of the application head assembly retracts the application roller in according to a pre programmed virtual cam profile so that the roller profiles or follows the curvature of the surface of the container precisely, thus maintaining substantially constant contact between the label web and the surface of the container. In this way, smooth and even label application is ensured.

In sequence D, the container 13 is shown as it moves further around the turret to a position where the center or axis of the container 13 forms an angle β with respect to the axis of the application roller. As the container moves through angle β, the application roller is moved by its servo drive inwardly relative to the turret according to the pre programmed virtual cam profile so that the surface of the roller and the label web each profile or follow the now retreating surface contour of the passing container. Thus, the roller and web stay in contact with the container so that the remainder of the label is transferred from the web to the container surface in a smooth and even fashion. Again, the angle β can be any appropriate angle, but generally is within the range of about 5 degrees to about 15 degrees depending upon container size and other factors and, in the illustrated embodiment, is about 10 degrees.

Once the label is applied to the container at sequence D, the servo drive of the label application assembly may stop the radially inward movement of the application head and roller and hold the application roller in a ready position as shown in sequence E in preparation for applying a label to the next successive container 13 in the same manner. If the angles α and β are the same, then the ready position of the application head is the same as the position it is in upon completion of the previous application and the roller need only be stopped in this position. However, if α and β are different, the application roller may be repositioned to the appropriate ready position between labeling activity.

When repositioning the turret for the next label application, the turret preferably is rotated at a higher rotational rate than when the labels are being applied. This modulation of turret rotation improves throughput while allowing sufficient time for efficient label application when the labels are actually being applied. As described in more detail above, it has been found advantageous, but not necessary, to program the rotation of the turret such that, on average, fifty percent of the time is spent transitioning at a higher rate from one container to the next and fifty percent of the time is spent actually applying labels to containers. Such an arrangement has proven to provide a good balance of throughput and smooth operation. Other ratios are possible and within the scope of the invention.

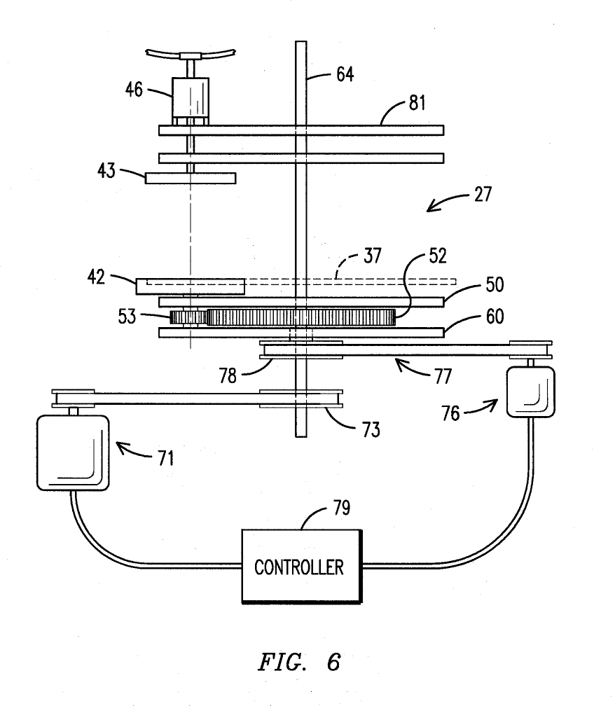

FIG. 6 is a simplified schematic diagram illustrating the independently controllable servo drives of the turret 27 and container bay bases 42. The turret 27 has a central shaft 64 to which support plates 50 and 60 and turret plate 37 are attached. A cap plate 81 also is attached to the central shaft 64 and carries the caps 43 of the container bays, which can be actuated by actuators 46 to move downwardly to capture containers in the bays. A drive coupling 73 is secured to the central shaft 64 and is coupled through a drive train 72 to a servo motor 71. In the simplified schematic of FIG. 6, the drive coupling is represented by a pulley and the drive trail is represented by a belt connecting the pulley to the motor. It will be understood by those skilled in the art however that the drive train may be and likely is substantially more complex than that illustrated in FIG. 6 and may include gear boxes, reducers, idlers, and the like where needed. Such drive trains are known by those skilled in the art and need not be described in detail here. In any event, the servo motor 71 is connected to a controller 79 programmed to drive the motor at predetermined, varying, and programmed rotation rates and thereby to rotate the turret 27 in virtually any controlled pattern.

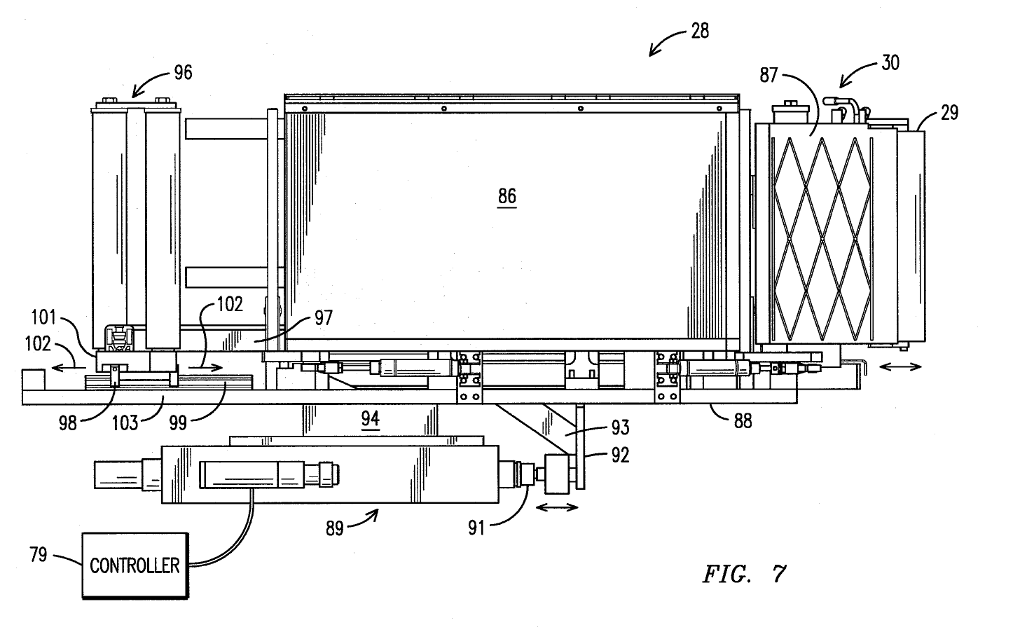

Sun gear 52 is disposed between the support plates 50 and 60 and is rotatably independently of the turret but about the same rotational axis. Each base 42 has a shaft that extends between the support plates 50 and 60 and a planetary gear 53 is mounted on the shaft between the plates. The planetary gear has teeth that mesh with the teeth of the sun gear 52 such that rotation of the sun gear causes the planetary gears and their bases to rotate in the opposite direction and at a rate determined by the ratios of the gears. A drive coupling 78 is secured to a hub of the sun gear 52 and is coupled through a drive train 77 to servo motor 76. Again, the drive train and drive coupling are simply illustrated here, but may be substantially more complex in a functioning apparatus and may include many additional components. The servo motor 76 is connected to and controlled by the controller 79 so that the motor 76 can be rotated according to any rotational rate pattern programmed into the controller. Further, it will be clear from FIG. 7 that the turret and the bases of the container bays are rotatably by their respective servo motors independently of each other. Thus, the turret may be rotated according to a predetermined programmed pattern and containers disposed on the container bay bases also may be rotated according an independent programmed pattern. In this way, the relative rotations and rotational patterns of the turret and container bays described in detail above can be achieved through appropriate programming of the controller 79.

FIG. 7 is a side elevational view of the application head assembly 28 illustrating one configuration of a servo controlled actuator for moving the application head assembly and roller 29 toward and away from the turret. Generally, the application head assembly comprises a front portion 30 that carries a platen 87 and the application roller 29, and a rear portion that carries rollers 96. The rear portion and front portion are connected together by an elongated aluminum extrusion 97 that rigidly secures the portions together to define the head assembly 28. The rear portion includes a mounting block 101 that includes a linear bearing 98 slidably coupled to a guide rail 99 fixed to mounting plate 103 so that the rear portion of the head assembly 28 is free to move forward and backward in the directions indicated by the arrows 102. Although not visible in FIG. 7, the front portion of the application head 28 includes horizontally extending stainless steel guide rods each of which is slidably disposed within a pair of fixed high temperature bushings. Thus, the front portion of the application head assembly also is free to move forward and backward as its guide rods slide within their respective bearings.

A servo controlled linear actuator 59 is secured beneath the mounting plate 103 on a mounting bracket 94. The actuator 59 generally is of known construction and includes a shaft 91 that moves linearly in and out of the actuator as a function of control commands provided to the actuator by the controller 79. The forward end of the shaft 91 is connected to a slide plate 92 from which an angled connecting bar extends. Although not visible in FIG. 7, the angled connecting bar extends through the mounting plate 103 and is attached to the rigid aluminum extrusion 97 that connects the forward and rear ends of the application head assembly 28 together. It will thus be seen that commanding the servo controlled the linear actuator 59 to extend its shaft 91 in turn causes the entire application head assembly 28 to move forward or to the right in FIG. 7. Conversely, commanding the actuator to retract is shaft 91 causes the entire application head assembly, including the roller 29, to move rearward or to the left in FIG. 7. In this way, the programmable controlled movement of the application head and roller according to the methodology of this disclosure can be obtained by programming virtual cam curves into the controller, which, in turn, move the application roller 29 and a web moving around it toward and away from the turret as described in detail above.

The invention has been described herein in terms of preferred embodiments, methodologies, and particular configurations of heat transfer labeling machine components. It will be apparent; however, that these are exemplary only and that a wide range of improvements, additions, deletions, and modifications might well be made to the illustrated embodiments, methodologies, and configurations within the scope of the invention. For example, the application head has been illustrated in a particular configuration to illustrate and enable the invention. Application heads of other constructions and attributes may be substituted. The illustrated mechanisms for moving containers through the various stations of the labeling machine also may be vastly different depending upon the particular machine. The invention is not limited to such details. These and other additions, deletions, and modifications might well be made to the illustrated embodiments without departing from the spirit and scope of the invention as set forth in the claims.

What is claimed is:

1. A method of applying a label to a container, the method comprising the steps of:
(a) moving the container progressively along a path toward, into alignment with, and past a labeling station;
(b) rotating the container about its axis as the container moves toward, into alignment with, and past the labeling station;
(c) engaging the container tangentially with a moving web that carries labels prior to alignment of the container with the labeling station to begin the transfer of a label from the web to the container; and
(d) moving the web away from and then toward the path such that the label follows the contour of and maintains contact with the container as the container moves into alignment with and past the labeling station to complete transfer of the label to the container.

2. The method of claim 1 and where in step (a) the path is substantially circular.

3. The method of claim 2 and wherein step (b) comprises rotating the container in the same direction that the container is moving around the circular path.

4. The method of claim 2 and wherein step (a) further comprises locating the container on a rotating turret to move the container along the circular path.

5. The method of claim 4 and wherein step (b) comprises locating the container on a rotating base associated with the rotating turret.

6. The method of claim 5 and wherein step (b) further comprises rotating the base independently of the turret.

7. The method of claim 1 and wherein step (c) comprises extending the web around a roller and engaging the container with the web and roller.

8. The method of claim 7 and wherein step (d) comprises moving the roller away from and then toward the path.

9. The method of claim 8 and further comprising coupling the roller to a servo actuator and commanding the actuator to move the roller away from and then toward the path.

10. The method of claim 1 and further comprising moving additional containers successively along the path for applying labels to the additional containers.

11. The method of claim 10 and further comprising increasing the rate of movement of the containers along the path when a label is not being applied to a container.

12. The method of claim 11 and wherein the increase in rate is predetermined such that the ratio of time during which labels are applied to the time when labels are not being applied is a predetermined value.

13. The method of claim 12 and wherein the predetermined value is about 1.

14. A method of applying heat transfer labels to a plurality of containers comprising the steps of:
(a) moving the containers in spaced sequence around a rotating turret to align the surfaces of the containers sequentially with a labeling station;
(b) rotating the containers about their respective axes during at least a portion of the time during which they approach, align with, and pass the labeling station;
(c) engaging one of the containers with a label contained on a moving web as the container approaches the labeling station;
(d) tracking the contour of the container with the web to maintain engagement between the label and the container as the container aligns with and moves past the labeling station to transfer the label to the container;
(e) repositioning the turret for application of a label to the next successive container; and
(f) repeating steps (c), (d), and (e) for the next successive container.

15. The method of claim 14 and wherein step (b) comprises rotating the container in the same rotational direction as the turret.

16. The method of claim 14 and wherein step (c) comprises moving the web across an application roller and positioning the roller to engage the container with the web.

17. The method of claim 16 and wherein step (d) comprises moving the roller with respect to the turret.

18. The method of claim 17 and wherein moving the roller comprises retracting the roller away from the turret until the container aligns with the labeling station.

19. The method of claim 18 and wherein moving the roller further comprises extending the roller toward the turret after the container aligns with the labeling station.

20. The method of claim 14 and wherein step (e) comprises increasing the rotational speed of the turret as it is repositioned.

21. The method of claim 20 and wherein the increased rotational speed is predetermined to ensure that the ratio of time during which labels are being applied to the time labels are not being applied is a predetermined value.

22. The method of claim 21 and wherein the predetermined value is such that about fifty percent of the time is spent applying labels and about fifty percent of the time is spend repositioning the turret.

23. An apparatus for applying labels to containers comprising:
a rotatable turret:
an array of rotatable container bays disposed about the rotatable turret;
a first drive mechanism for rotating the turret;
a second drive mechanism for rotation containers within the container bays;
an application head including an application roller disposed adjacent the turret and being movable to extend the application roller toward and retract the application roller away from the turret, the application head being configured to move a web containing labels across the application roller;
a third drive mechanism for moving the application head in a predetermined pattern toward and away from the turret as containers move past the roller; and
a controller coupled at least to the third drive mechanism, the controller being programmed to move the application roller such that it engages and follows the profiles of the surfaces of containers in the container bays as the containers approach, align with, and pass the application roller to transfer labels from the web to the containers.

24. The apparatus of claim 23 and wherein the controller is coupled to the third drive mechanism is a servo drive.

25. The apparatus of claim 23 and wherein the first, second, and third drive mechanisms comprise servo drives and wherein each drive mechanism is couple to and controlled by the controller according to preprogrammed instructions.

26. The apparatus of claim 25 and wherein the controller is programmed to cause the application roller to engage each container tangentially a first predetermined angle of rotation of the turret before the container aligns with the roller.

27. The apparatus of claim 26 and wherein the controller is programmed to cause the roller to maintain its engagement with the container until a second predetermined angle of rotation of the turret after the container aligns with the roller.

28. The apparatus of claim 27 and wherein the second predetermined angle of rotation is between about 5 and about 12 degrees.

29. The apparatus of claim 28 and wherein the second predetermined angle of rotation is about 10 degrees.

30. The apparatus of claim 26 and wherein the first predetermined angle of rotation is between about 5 and about 12 degrees.

31. The apparatus of claim 30 and wherein the first predetermined angle of rotation is about 10 degrees.

32. The apparatus of claim 25 and wherein the controller is programmed to increase the rotational speed of the turret when labels are not being applied.

33. The apparatus of claim 32 and wherein increase in rotational speed is predetermined such that about fifty percent of the time is spent applying labels to containers and about fifty percent of the time is spent repositioning the turret for application of labels to successive containers.
